(19) United States
(12) Patent Application Publication
(10) Pub. No.: US 2007/0213043 A1
(43) Pub. Date: Sep. 13, 2007

(54) Method of finding person using mobile messenger service and systems thereof

(75) Inventor: Jae Hong Son, Buchun-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/517,445

(22) Filed: Sep. 8, 2006

(30) Foreign Application Priority Data
Sep. 9, 2005 (KR) 10-2005-0084093

(51) Int. Cl. H04Q 7/20

(52) U.S. Cl. 455/422.1

(57) ABSTRACT

A method and system for finding a person using a mobile messenger service in a mobile communication terminal including a global positioning system (GPS) module are provided. The method includes providing a location finding method using a mobile messenger service, the method comprising: providing a mobile messenger service to a mobile communication terminal in which a position detecting module is provided; receiving information on access to the mobile communication terminal and information on registration of counterpart mobile communication terminals registered with the mobile messenger service, so as to generate information on locations of the mobile communication terminal and the counterpart mobile communication terminals and to generate map information to which the location information is mapped; and providing the map information to the mobile communication terminal.

This nonprovisional application claims priority under 35 U.S.C. § 119(a) on Patent Application No. 10-2005-0084093 filed in Republic of Korea on Sep. 9, 2005, the entire contents of which are hereby incorporated by reference.

### BACKGROUND OF THE INVENTION

1. Field of the Invention

The present invention relates to a method of finding a person using a mobile messenger service and a system thereof, and more particularly, to a method of finding a person using a mobile messenger service in a mobile communication terminal including a global positioning system (GPS) module in which information on the locations of counterparts who access the mobile communication terminal is provided by various information items based on map information using the mobile messenger service and a system thereof.

2. Description of the Background Art

In general, a location based service (LBS) in which a mobile communication network and information technology (IT) are used is spotlighted in traffics, logistics, and electronics commercial transactions with the development of the mobile communication networks such as IMT-2000 and an intelligent transportation system (ITS). Various LBSs such as a public security service, a location service, a navigation service, and an information provision service are provided using a global positioning system (GPS) or a mobile communication network based location recognition system. It is expected that precise location recognition may be possible in rooms, under the ground, and in areas where buildings are densely aggregated, which are not covered by a conventional location recognition system due to the limitations of wireless circumstances, using the next generation mobile communication technology. However, it is regulated by laws not to unconditionally provide information on the location of a user.

As the use of the mobile communication terminal increases, recognition of locations using the GPS increases. For example, an automatic access notification method using a mobile communication terminal including a GPS receiving unit is disclosed in Korean Patent Registration No. 442032 under the title “Access Notification Method between Terminals Using GPS Mobile Communication Terminal”. In the method disclosed in Korean Patent Registration No. 442032, the location of a terminal registered as an object whose access is to be notified is monitored by a home location register (HLR) using the mobile communication terminal including the GPS receiving unit and, when at least one of the objects whose access is to be notified is within a predetermined distance, a switch to a GPS location checking mode is performed. The correct current location (GPS location) of the corresponding terminal is calculated using the GPS signal received from the terminal whose access is to be notified, and a message including the GPS location is generated so that the message is transmitted to another terminal whose access is to be notified.

In the above-described method, location information is provided by a character message when the specific terminal set by a user is within a predetermined distance. That is, in the above-described method, the location information is once or repeatedly provided by the character message using the registered terminal.

Also, in the LBS using the conventional mobile communication terminal, road information is provided so that a user can move to a destination. However, there is no service in which information on the locations of counterparts to be found is provided by map information and distance information. Therefore, it is necessary to provide the location information to the mobile communication terminal in various forms so that it is possible to easily find a person.

### SUMMARY OF THE INVENTION

In order to address the limitations and disadvantages associated with the background art, the present invention has been made in an effort to provide an apparatus for finding a person or other object using a mobile messenger service in which access to a mobile messenger service is made through a mobile communication terminal including a global positioning system (GPS) module so that information on the locations of selected counterparts is provided by various map information items, and to provide a method thereof.

A person finding system using a mobile messenger service according to an aspect of the present invention includes a mobile messenger server for providing a mobile messenger service to a mobile communication terminal in which a GPS module is mounted and for providing information on access to the mobile communication terminal and information on registration of the counterpart mobile communication terminals registered in the list of the mobile messenger service of the mobile communication terminal, and a GPS server for receiving the access information and the registration information to generate information on the locations of the mobile communication terminal and the counterpart mobile communication terminals, to generate map information to which the generated location information is mapped, and to provide the generated map information to the mobile communication terminal. The system preferably further includes a location information database for storing and providing the access information, the registration information, and the map information.

A person finding method using a mobile messenger service according to another aspect of the present invention includes providing a mobile messenger service to a mobile communication terminal in which a global positioning system (GPS) module is mounted, receiving information on access to the mobile communication terminal and information on registration of counterpart mobile communication terminals registered in the list of the mobile messenger service of the mobile communication terminal to generate information on the locations of the mobile communication terminal and the counterpart mobile communication terminals and to generate map information to which the location information is mapped, and providing the map information to the mobile communication terminal.

According to an aspect of the present invention, there is provided a location finding method using a mobile messenger service, the method comprising: providing a mobile messenger service to a mobile communication terminal in which a position detecting module is provided; receiving information on access to the mobile communication terminal and information on registration of counterpart mobile communication terminals registered with the mobile messenger service, so as to generate information on locations of the mobile communication terminal and the counterpart mobile communication terminals and to generate map information to which the location information is mapped; and providing the map information to the mobile communication terminal.

According to an aspect of the present invention, there is provided a location finding system using a mobile messenger service, comprising: a mobile communication terminal in which a position detecting module is mounted; a mobile messenger server for providing a mobile messenger service to the mobile communication terminal and for providing information on access to the mobile communication terminal and information on registration of counterpart mobile communication terminals registered with the mobile messenger service; and a location server for receiving the access information and the registration information to generate information on locations of the mobile communication terminal and the counterpart mobile communication terminals, to generate map information to which the generated location information is mapped, and to provide the generated map information to the mobile communication terminal.

According to an aspect of the present invention, there is provided a mobile terminal comprising: a global positioning system (GPS) module to provide access information of the mobile terminal to a server via a network; and a controller configured to provide a mobile messenger service, wherein the controller receives map information to which location information of the mobile terminal and counterpart mobile terminals is mapped using the access information, in response to a user's selection of the mobile messenger service; and a display unit configured to display the received map information.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1 illustrates the structure of a system for providing a method of finding a person using a mobile messenger service according to an embodiment of the present invention;

FIG. 2 illustrates an example of a mobile messenger service screen, which can be the screen of a mobile terminal, according to an embodiment of the present invention;

FIG. 3 illustrates an example of a screen on which distance information is displayed in the method of finding a person using the mobile messenger according to an embodiment of the present invention, wherein the screen can be the screen of a mobile terminal;

FIG. 4 illustrates an example of a screen on which path information is displayed in the method of finding a person using the mobile messenger according to an embodiment of the present invention, wherein the screen can be the screen of a mobile terminal;

FIG. 5 illustrates an example of a screen on which shortest distance information is displayed using geographical information in the method of finding a person using the mobile messenger according to an embodiment of the present invention, wherein the screen can be the screen of a mobile terminal; and

FIG. 6 is a flowchart describing the method of finding a person using the mobile messenger according to an embodiment of the present invention.

### DETAILED DESCRIPTION OF PREFERRED EMBODIMENTS

Preferred embodiments of the present invention will be described in detail with reference to the accompanying drawings.

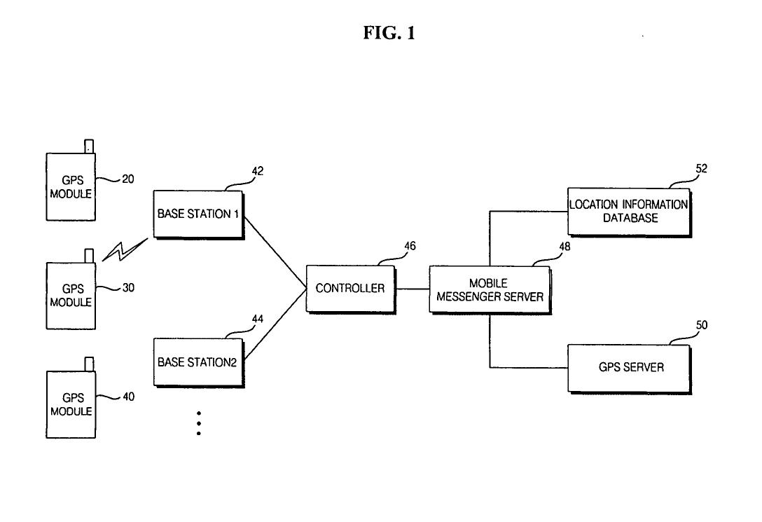

FIG. 1 illustrates the structure of a system for providing a method of finding a person using a mobile messenger service according to the present invention. The system illustrated in FIG. 1 includes mobile communication terminals 20, 30, and 40, first and second base stations 42 and 44, a controller 46, a mobile messenger server 48, a global positioning system (GPS) server 50, and a location information database 52. All the components of the system are operatively coupled and configured.

Each of the mobile communication terminals 20, 30, and 40 includes a GPS module (or other location detecting module), and the first and second base stations 42 and 44 are controlled by the controller 46 to set a communication channel and to control transmission and reception speed. The controller 46 is positioned between the mobile messenger server 48 and the first and second base stations 42 and 44 to manage the first and second base stations 42 and 44 and to set and cancel a call when a service of finding a person is performed by the mobile communication terminals 20, 30, and 40.

The mobile messenger server 48 provides messenger services such as voice communication, picture communication, and message transmission between counterparts or groups through the mobile communication terminals 20, 30, and 40. For the convenience sake, only as an example, assume that the mobile communication terminal 20 accesses a mobile messenger service and that the mobile communication terminals 30 and 40 are counterpart mobile communication terminals registered in the mobile messenger service.

When a user accesses the messenger service through the mobile communication terminal 20, the GPS server 50 (or other location server) receives information on the access of the user to the mobile communication terminal 20 and information on the registration of the counterpart mobile communication terminals 30 and 40 registered in the list of the mobile messenger service from the mobile messenger server 48. The GPS server 50 receives the locations of the user and the counterparts from the GPS modules of the mobile communication terminal 20 of the user and the counterpart mobile communication terminals 30 and 40 to grasp the locations of the user and the counterparts in accordance with the information on the access of the user to the mobile communication terminal 20 and the information on the registration of the counterpart mobile communication terminals 30 and 40 that are received from the mobile messenger server 48. Location information including information on the distances between the user and the counterparts is obtained and stored in the location information database 52.

The location information database 52 receives the information on the access of the user to the mobile messenger service and the information on the registration of the counterparts from the mobile messenger server 48 to record and store the same. Also, the location information database 52 receives the location information including the information on the distances between the user and the counterparts that is provided by the GPS server 50 to record and store the same, and provides the location information to the mobile messenger server 48 and the GPS server 50, if necessary.

When the user accesses the mobile messenger service using the mobile communication terminal 20, the GPS server 50 checks authentication information to know whether the user and the counterparts passed through authentication processes required for providing the location information. Then, the locations of the user and the counterparts are grasped by communicating information on the telephone numbers of the user and the counterparts or the GPS modules included in the counterpart mobile communication terminals 30 and 40, and the location information is obtained using the grasped locations. At this time, a method similar to a triangular measurement may be used for grasping the locations of the user and the counterparts, and it is possible to correctly grasp or determine the locations of the user and the counterparts when the plurality of GPS modules are involved.

The GPS server 50 maps the location information including the information on the distances between the user and the counterparts to map information, so as to generate the map information that can be recognized by the mobile communication terminal 20 of the user. The GPS server 50 stores the generated map information in the location information database 52, and provides the generated map information to the terminal 20 when it is requested by the mobile communication terminal 20 of the user so that the user can easily and correctly find the locations of the counterparts while looking at the map information displayed on the terminal 20. The information on the locations of all the counterparts that is requested by the user can be provided even when the user's request is simultaneously made with respect to the plurality of counterparts.

As described above, according to the present invention, the map information obtained by mapping the location information (e.g., on a geographical or street map) is provided to the mobile communication terminal of the user when the information on the locations of the counterparts is provided. For instance, the information on the distances between the user and the counterparts, the path information such as information on the roads between the user and the counterparts over a map, and the information on the shortest distances between the user and the counterparts are provided on the map information screen of the terminal 20. Such information can be provided over a map or in other format for easy navigation.

The mobile communication terminals 20, 30, and 40 can display the map information. Map information materials are included in the map information generated by the GPS server 50 to be provided to the mobile communication terminal 20 of the user in order to provide correct information on the locations of peripheral buildings, schools, signal lamps, and government and public offices based on the current location of the user. The GPS server 50 receives the location information on the coordinates of the user and the plurality of counterparts from the GPS module(s) of the mobile communication terminal(s) and matches the location information to the map information screen and to show the map information including the location information on the screen of the user's mobile terminal.

In the above-described structure, when the user accesses the mobile messenger service by the mobile communication terminal 20 including the GPS module, the mobile messenger server 48 provides the information on the access of the user and the information on the registration of the counterpart mobile communication terminals 30 and 40 registered by the user in the list of the mobile messenger service, to the GPS server 50. The GPS server 50 receives the information from the messenger server 48 and then generates the information on the locations of the user and the registered counterparts and generates the map information in accordance with the location information. The GPS server 50 records and stores the generated map information in the location information database 52. The map information can be previously generated to reduce the speed at which the messenger service is provided.

When the user selects a person finding menu in the mobile communication terminal 20, the GPS server 50 transmits the generated map information to the mobile communication terminal 20 of the user so that the transmitted map information is displayed, e.g., on the screen of the terminal 20 or other associated screen. When the user desires more precise information, the user selects a detailed menu to check for more desired map information and to obtain more detailed location information of the counterparts and/or the user.

When the user does not select the person finding menu, the map information is not provided to the user and the user can still use services such as voice communication and picture communication with the counterparts using the mobile messenger service.

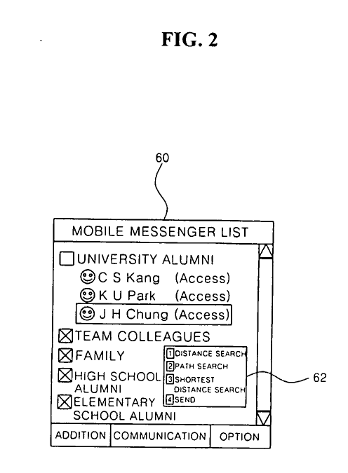

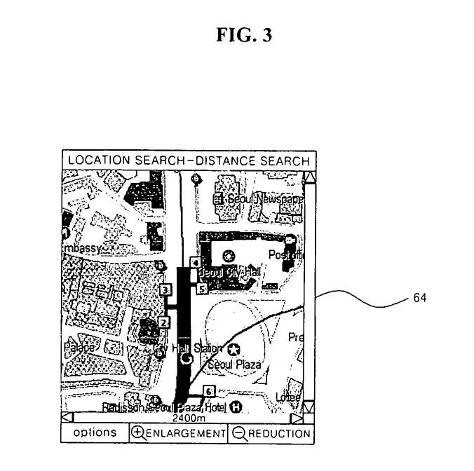

FIG. 2 illustrates an example of a mobile messenger service screen according to the present invention. The user selects a mobile messenger service menu using the mobile communication terminal 20 so that the list of the counterparts registered by the user is displayed on a service screen 60 (e.g., of the terminal 20) as illustrated in FIG. 2. When the user selects a friend (e.g., J H Chung) whose location is to be found from the list of the user's university alumni, the user selects one from sub menus 62 such as distance search, path search, and shortest distance search to request selected information on the location of the friend. Examples of the distance search, path search, and shortest distance search available on the sub menus 62 are discussed below in more detail referring to FIGS. 3-5. Also, the user may request the distance information when the counterparts in the list of team colleagues, high school alumni, and elementary school alumni access the mobile messenger service. That is, the distance information may be requested for a plurality of people at one time.

FIG. 3 illustrates an example of a screen on which distance information is displayed in response to the user requesting information on the locations of the counterparts who access the mobile messenger service in the method of finding a person using the mobile messenger according to the present invention. In FIG. 3, a screen 64 on which information on the calculated distances between the user and the counterparts is displayed is illustrated. The calculated distance can be shown as part of the map information. The displayed map information may be enlarged and reduced. The GPS server 50 receives the location information from the GPS modules included in the mobile communication terminals 20, 30, and 40 of the user and the counterparts in the above-described method, calculates the correct locations of the user and the counterparts, maps the locations of the user and the counterparts to general map information (which can be prestored), and transmits the map information (including the location information mapped thereto) to the mobile communication terminal 20 of the user, so that the map information can be displayed on the screen 64 for the user. In this example, an exact distance (e.g., in meters or kilometers, etc.) between the user and any of the selected counterpart(s) may be displayed on the screen 64. Using the map information of the user and counterparts, the user can see where the counterparts are with respect to the user and each other.

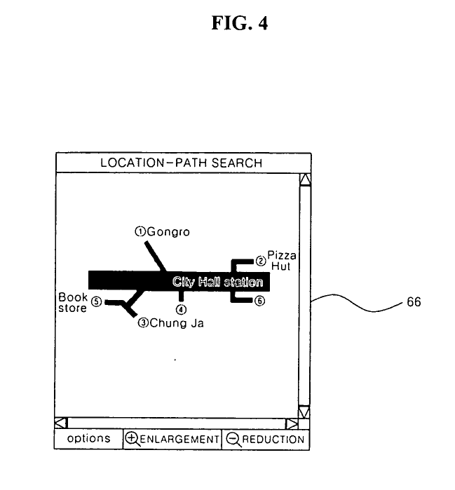

FIG. 4 illustrates an example of a screen on which information on the paths between the user and the counterparts is displayed. In FIG. 4, a screen 66 on which the paths between the user and the counterparts are displayed based on road information is illustrated. The displayed path information (which can be referred to as map information) may be enlarged and reduced. The user grasps the area in which the counterparts are located through the path information displayed on the screen 66.

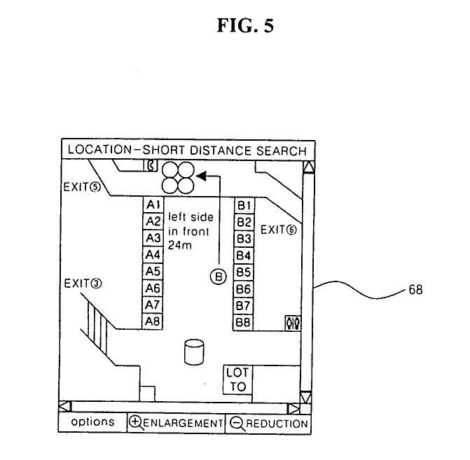

FIG. 5 illustrates an example of a screen providing information on the shortest distance(s) between the user and the counterparts by map information. In FIG. 5, a screen 68 shows the user can easily find and meet the counterparts using the shortest distance search option on the submenu 62 although the user does not know the corresponding area. Such a function may be used when the distances between the user and the counterparts short and/or when the area is crowded. It is possible to correctly display detailed information on the surroundings and the locations of the counterparts using the shortest distance search function, which can be a useful navigation tool. Since the directions and distances are provided, it is possible to easily find the counterparts. The displayed map information may be enlarged and reduced. In FIG. 5, the user moves to the place where the counterparts are currently located while looking at the arrow of the displayed screen 68 to meet the counterparts.

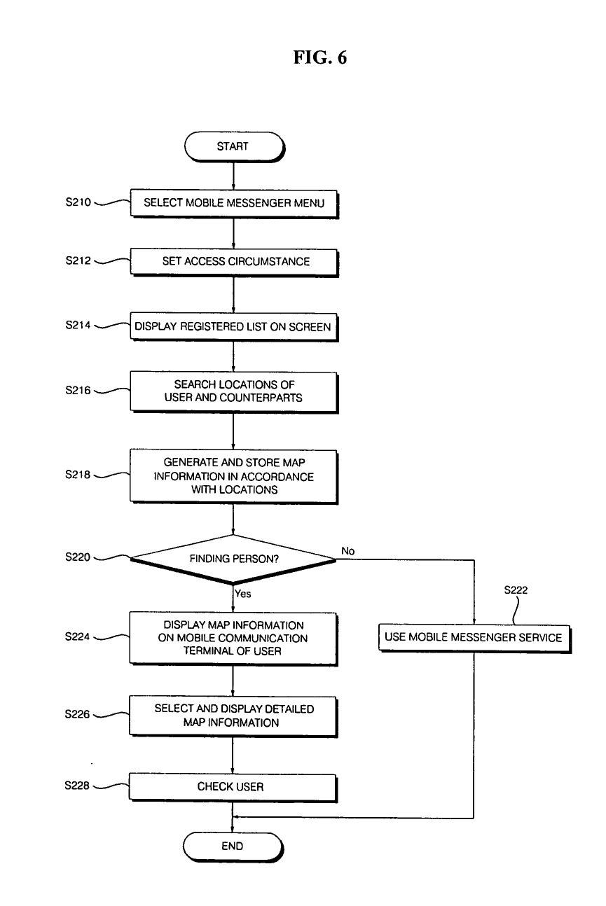

FIG. 6 is a flowchart describing the method of finding a person using the mobile messenger according to the present invention. This method can be implemented using the system of FIGS. 1-5 or using other suitable device/system.

Referring to FIG. 6, the user selects a mobile messenger menu on the screen of the mobile communication terminal 20 in order to use the mobile messenger service by the mobile communication terminal 20 in which the GPS module is mounted (S210) and then, sets an access circumstance/setting (S212). That is, when the user generates an entire group and a specific group in the setting of a messenger circumstance, sets his or her authentication information, and tries to log in the corresponding mobile messenger menu, the mobile communication terminal 20 accesses the mobile messenger server 48 through the base station of a wireless network and the controller 46. When the setting of the access circumstance is completed so that the mobile messenger service starts, a list registered by the user is displayed on the screen of the mobile communication terminal 20 of the user (S214).

The mobile communication terminal 20 of the user periodically pages the mobile messenger server 48 through the wireless network. The mobile messenger server 48 determines whether the user accesses the current messenger service to generate access/location information and continuously updates the access information to the location information database 52.

The GPS server 50 (or other location server) grasps the locations of the user and the counterparts from the information provided from the GPS modules (or other location detecting module) included in the mobile communication terminal 20 of the user and the counterpart mobile communication terminals 30 and 40 to generate the location information and to generate the map information (which includes the generated location information mapped thereto) in accordance with the user access information and the counterpart registration information that are received from the mobile messenger server 48 (S216 and S218).

The GPS server 50 provides the obtained location information to the location information database 52 so that the location information of the user and others is recorded and stored in the location information database 52. The GPS server 50 matches the collected location information on the locations of the user and the counterparts to the map information so that map information including the location information is generated and is stored in the location information database 52 (S218).

If the user does not select the person finding menu (to find a person), but selects the voice communication or picture communication also provided by the mobile messenger service, the generated map information is not provided to the user at this time so that the user can use the mobile messenger service in other capacity (S220 and S222).

On the other hand, if the user accesses the mobile messenger service and selects the person finding menu and other associated menus, the GPS server 50 transmits the previously generated map information (including the location information) to the mobile communication terminal 20 of the user so that the transmitted map information is displayed (S220 and S224). For instance, upon request, the screen can display various map information as shown in FIGS. 3-5 in response to the user's selection of the distance search, path search, or the shortest distance search available on the sub menus 62. When the map information includes the distance information, the map information can be available when the plurality of counterparts to be found exist.

The user can reduce and enlarge the displayed map information to check the map information. In the case where the user desires detailed map information, when the user requests the distance search, the path search, and the shortest distance search as illustrated in FIGS. 2 to 5, the GPS server 50 provides such detailed map information. The distance search provides the distances between the user and the counterparts and the map. The path search provides information on the roads between the user and the counterparts. The shortest distance search provides the map information and precise direction information so that the user and the counterparts can meet in the shortest distance. Therefore, when the user becomes close to the counterparts, the user can correctly grasp the locations of the user and the counterparts using the above-described path search and shortest distance search functions.

The user can meet the counterparts while looking at the detailed screen displayed on the mobile communication terminal 20 (S226 and S228). The displayed information such as the map information is periodically or continuously updated as the mobile communication terminals of the user and counterparts move.

When the user accesses the mobile messenger service using the mobile communication terminal by the above-described processes, the locations of the user and the counterparts registered in the list of the mobile messenger service are determined and the map information in accordance with the location information including the information on the distances between the user and the counterparts is generated. When the user requests the person finding information, the generated map information is provided to the mobile communication terminal of the user. The mobile communication terminal can be, but is not limited to, a mobile phone, a PDA, a smart phone, a smart MP3 player, etc.

As described above, according to the present invention, the user can access the mobile messenger service using the mobile communication terminal to communicate with the counterparts even by a picture telephone and to receive the information on the locations of the counterparts by the map. Since the messenger service used by a computer may be used by the mobile communication terminal through the wireless network, it is possible to utilize the convenient location information providing service anywhere and anytime.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A location finding method using a mobile messenger service, the method comprising:
providing a mobile messenger service to a mobile communication terminal in which a position detecting module is provided;
receiving information on access to the mobile communication terminal and information on registration of counterpart mobile communication terminals registered with the mobile messenger service, so as to generate information on locations of the mobile communication terminal and the counterpart mobile communication terminals and to generate map information to which the location information is mapped; and
providing the map information to the mobile communication terminal.

2. The method as claimed in claim 1, wherein the map information is provided when a person finding menu associated with the mobile messenger service is selected.

3. The method as claimed in claim 1,
wherein the map information is generated and stored in a database before a person finding menu associated with the mobile messenger service is selected, and
wherein, when the person finding menu is selected, the map information stored in the database is retrieved and provided to the mobile communication terminal.

4. The method as claimed in claim 1, wherein, when detailed information on the map information is requested by the mobile communication terminal, shortest distance information including information on the distances between the mobile communication terminal and the counterpart mobile communication terminals, path information, or direction information is provided to the mobile communication terminal.

5. The method as claimed in claim 1, further comprising:
periodically updating the map information in accordance with movement of the mobile communication terminal and the counterpart mobile communication terminals after generating the map information.

6. The method as claimed in claim 1, further comprising:
periodically paging the mobile communication terminal through a wireless network to grasp the access information.

7. A location finding method using a mobile messenger service, the method comprising:
executing a mobile messenger service in a mobile communication terminal in which a global positioning system (GPS) module is provided;
receiving map information to which information on locations of the mobile communication terminal and counterpart mobile communication terminals registered with the mobile messenger service is mapped; and
displaying the map information.

8. The method as claimed in claim 7, wherein the map information is provided when a person finding menu is executed in the mobile messenger service.

9. The method as claimed in claim 7, wherein the map information is generated by receiving information on access to the mobile communication terminal and information on registration of the counterpart mobile communication terminals to generate location information based on a GPS satellite signal and to map the generated location information to a map screen.

10. The method as claimed in claim 7, further comprising:
requesting, by the mobile communication terminal, detailed information on the map information; and
receiving shortest distance information including information on the distances between the mobile communication terminal and the counterpart mobile communication terminals, path information, or direction information in response to the detailed information requested in the requesting step.

11. The method as claimed in claim 7, further comprising:
enlarging and reducing the displayed map information in accordance with a command of a user.

12. The method as claimed in claim 7, further comprising:
receiving and displaying map information periodically updated in accordance with movement of the mobile communication terminal and the counterpart mobile communication terminals after receiving the map information initially.

13. A location finding system using a mobile messenger service, comprising:
a mobile communication terminal in which a position detecting module is mounted;
a mobile messenger server for providing a mobile messenger service to the mobile communication terminal and for providing information on access to the mobile communication terminal and information on registration of counterpart mobile communication terminals registered with the mobile messenger service; and
a location server for receiving the access information and the registration information to generate information on locations of the mobile communication terminal and the counterpart mobile communication terminals, to generate map information to which the generated location information is mapped, and to provide the generated map information to the mobile communication terminal.

14. The system as claimed in claim 13, further comprising:
a location information database for storing and providing the access information, the registration information, and the map information.

15. The system as claimed in claim 13, wherein the location server is a global positioning system (GPS) server and provides the map information when the map information is requested by the mobile communication terminal.

16. The system as claimed in claim 15, wherein the GPS server previously generates the map information prior to the map information request by the mobile communication terminal, and stores the map information in a database for subsequent access.

17. The system as claimed in claim 13, wherein the location server provides the map information to the mobile communication terminal when the mobile communication terminal executes a person finding menu.

18. The system as claimed in claim 13, wherein the location server provides shortest distance information including information on the distances between the mobile communication terminal and the counterpart mobile communication terminals, path information, or direction information when detailed information on the map information is requested by the mobile communication terminal.

19. The system as claimed in claim 13, wherein the location server periodically updates the map information in accordance with movement of the mobile communication terminal and the counterpart mobile communication terminals after generating the map information.

20. The system as claimed in claim 13, wherein the mobile messenger server periodically pages the mobile communication terminal through a wireless network to obtain the access information.

21. A mobile terminal comprising:
a global positioning system (GPS) module to provide access information of the mobile terminal to a server via a network; and
a controller configured to provide a mobile messenger service, wherein the controller receives map information to which location information of the mobile terminal and counterpart mobile terminals is mapped using the access information, in response to a user's selection of the mobile messenger service; and
a display unit configured to display the received map information.
